(19) United States
(12) Patent Application Publication
(10) Pub. No.: US 2012/0284192 A1
(43) Pub. Date: Nov. 8, 2012

(54) SYSTEM AND METHOD FOR REAL-TIME TRACKING ONE OR MORE TRANSACTIONS

(76) Inventor: TANSEL YILMAZ, Long Beach, CA (US)

(21) Appl. No.: 13/464,217

(22) Filed: May 4, 2012

Related U.S. Application Data
(60) Provisional application No. 61/482,600, filed on May 4, 2011.

(51) Int. Cl. G06Q 30/02; H04L 9/14

(52) U.S. Cl. 705/50; 705/14.41; 705/14.13; 705/14.1; 705/14.39

(57) ABSTRACT

The present invention is a system of real-time tracking one or more transactions that includes a server system that generates one or more offers and allows the one or more offers entered into the server system to track performance of the entered one or more offers, a memory system, one or more customers that enter the one or more specific offer numbers into the server system and one or more customers. The system also includes one or more merchants, an administrator, a token generator that generates a plurality of tokens and a plurality of websites that include a customer website and a merchant website. The present invention also includes a method for real-time tracking one or more transactions.

This application claims priority to U.S. Provisional Application 61/482,600 filed on May 4, 2011, the entire disclosure of which is incorporated by reference.

### TECHNICAL FIELD & BACKGROUND

The present invention relates generally to a system and method for tracking one or more transactions. More specifically, the present invention relates to a system and method for real-time tracking one or more transactions.

It is an object of the present invention to provide a system and method for real-time tracking one or more transactions to a plurality of merchants, a plurality of customers or, alternatively is provided as extra value.

It is an object of the present invention to provide a system and method for real-time tracking one or more transactions that provides a merchant with a unique token generator and a website where the merchant can publish a plurality of offers.

It is an object of the present invention to provide a system and method for real-time tracking one or more transactions that can also track a plurality of merchant offerings, a plurality of customers, a plurality of customer transaction times, the transaction locations and a plurality of most or all possible demographic data from the transaction.

What is needed is a system and method for real-time tracking one or more transactions that are obtained at no cost to a plurality of merchants, a plurality of customers or, alternatively is provided as extra value that provides a merchant with a unique token generator and a website where the merchant can publish a plurality of offers that can also track a plurality of merchant offerings, a plurality of customers, a plurality of customer transaction times, the transaction locations and a plurality of most or all possible demographic data from the transaction.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a diagram of a system overview of a system of real-time tracking one or more transactions, in accordance with one embodiment of the present invention.

FIG. 2 illustrates a block diagram of a server system of a system of real-time tracking one or more transactions, in accordance with one embodiment of the present invention.

FIG. 3 illustrates a block diagram of a client system of a system of real-time tracking one or more transactions, in accordance with one embodiment of the present invention.

FIG. 4 illustrates a flowchart of a method for real-time tracking one or more transactions, in accordance with one embodiment of the present invention.

FIG. 5 illustrates a flowchart of a method for generating an offer with a specific corresponding offer code, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

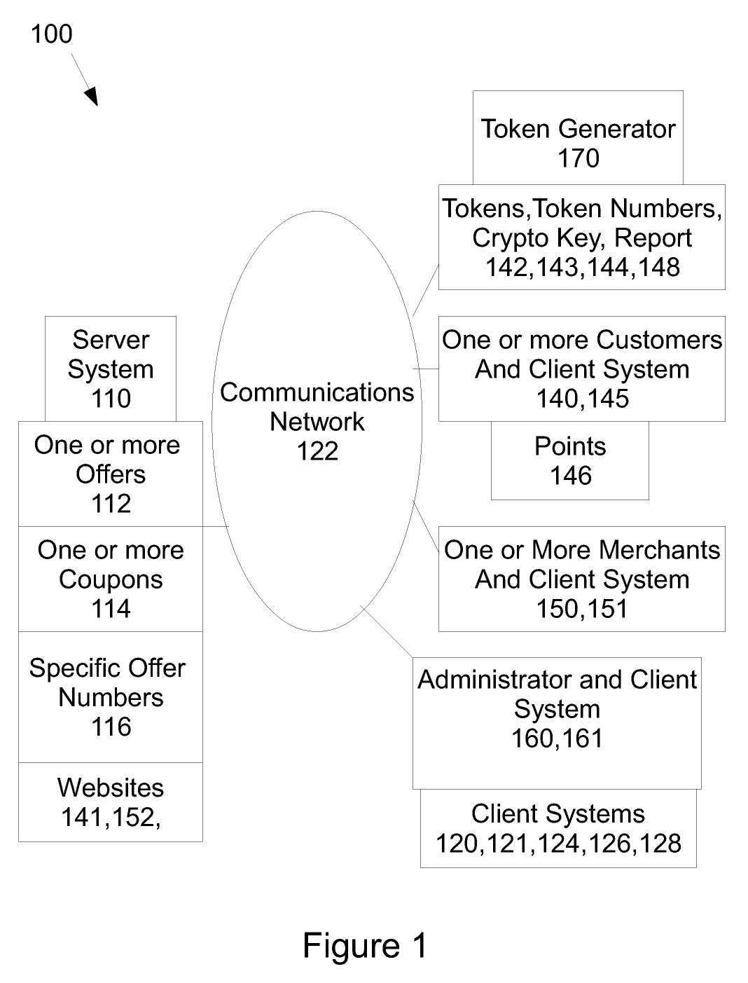

FIG. 1 illustrates a diagram of an overview of a system 100 of real-time tracking one or more transactions, in accordance with one embodiment of the present invention.

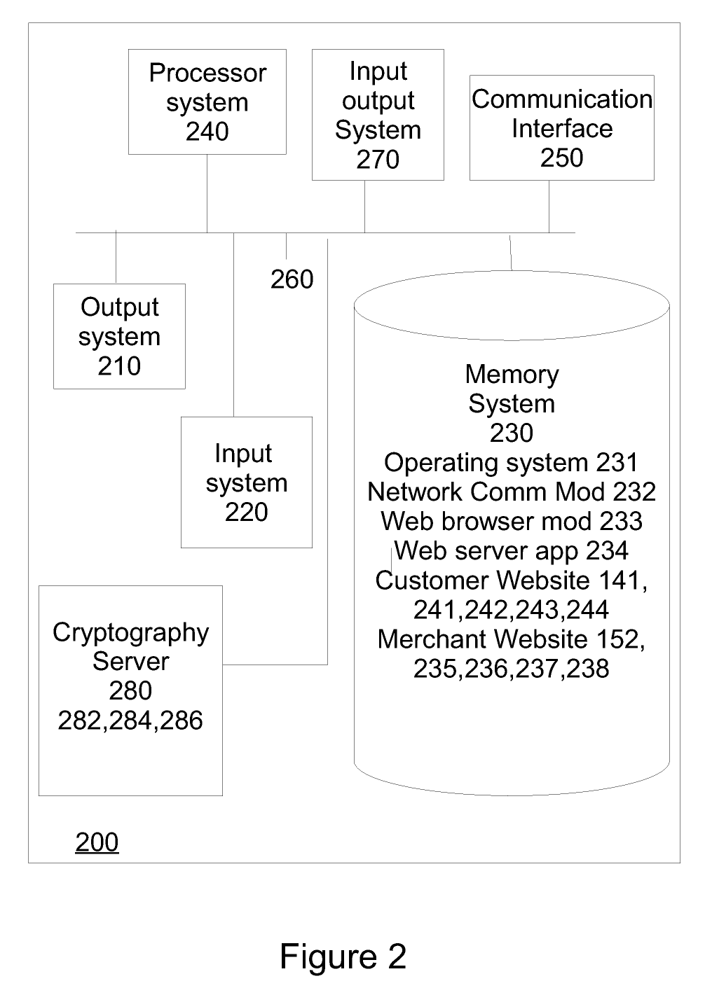

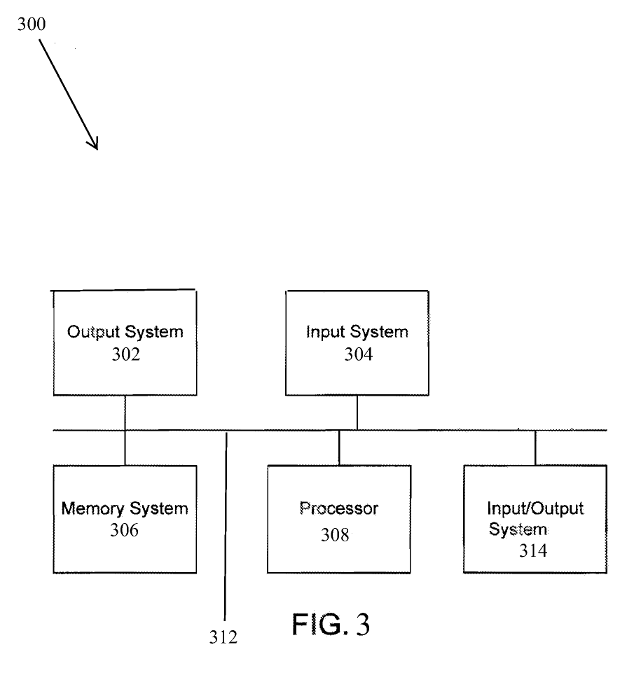

The system 100 includes a server system 110, a plurality of client systems 120, one or more customers 140, one or more merchants 150, an administrator 160 and a token generator 170. The server system 110 generates one or more offers 112 and allows one or more offers 112 to be entered into the server system 110 and to track performance of the entered offers 112. The one or more offers 112 can also be a coupon 114 or other suitable offer. The one or more offers 112 include a specific offer number 116 that corresponds to each one or more offers 112. Additional details regarding the server system 110 are provided in FIG. 2 and its description. The client systems 120 are in communication with the server system 110 and allow access to the server system 110 through a communications network 122. The client systems 120 can be a smartphone 121, a table computer 124, a laptop computer 126, a personal computer 128 or any other suitable client system 120. Additional details regarding the client systems are provided in FIG. 3.

The one or more customers 140 can enter any one or more specific offer numbers 116 of the one or more offers 112 into the server system 110 utilizing a client system 120. The one or more customers 140 can also receive any one or more offers 112 from the server system 110 based on a plurality of preferences such as age, location, gender or any other suitable preferences. The one or more customers 140 can patronize a retail location or other suitable location to redeem the one or more offers 112 with a merchant 150 by utilizing a client system 120. The merchant 150 then generates a plurality of tokens 142 with a specific token number 144 that that corresponds to each token 142. The tokens 142 produce a cryptographic key 143 The server system 110 can also track merchant offerings, the one or more customers, one or more customer transaction times, one or more transaction locations and other suitable demographic data. The one or more customers 140 may then enter the specific token number 144 into the server system 110 and earn a plurality of points 146. The one or more customers 140 may also track the points 146 that reside on the server system 110 in real-time with a customer client system 145. The one or more customers 140 can also track earned points 146 in real-time by accessing a customer website 141 that resides on the server system 110.

The one or more merchants 150 can change or modify any one or more offers 112 that reside on the server system 110 in real-time utilizing a merchant client system 151 and provide updated information regarding the one or more offers 112 on a merchant website 152 that reside on the server system 110. The one or more merchants 150 can also publish one or more offers 112 on the merchant website 152 that resides on the server system 110. Additionally the administrator 160 can change or modify any one or more offers 112 that reside on the server system 110 in real-time utilizing an administrator client system 161 and provide updated information regarding the one or more offers 112 on a merchant website 152 that resides on the server system 110 as well.

The token generator 170 is utilized by the merchant 150 that generates a plurality of tokens 142 with a specific token number 144 that corresponds to each token 142 as previously described. The token generator 170 generates the tokens 142 with a one-time development cost that can be replicated at relatively little cost. The token generator 170 includes software (not shown) that can be installed on a merchant's desktop machine, or in a POS system, or on a token generator mobile device. An API is also provided (not shown) and is a standalone system separate from the client system 120.

FIG. 2 illustrates a block diagram of a server system of a system of real-time tracking one or more transactions, in accordance with one embodiment of the present invention.

The server system 200 may include an output system 210, an input system 220, a memory system 230, a processor system 240, a communications interface 250, a communications system 260 and an input/output system 270. The server system 200 may include additional components and/or may not include all of the components listed above. The server system 200 is a similar server system 110 illustrated and described in FIG. 1 and its description.

The output system 210 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or Internet, for example.

The input system 220 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or Internet (e.g., IrDA, USB), for example.

The memory system 230 may include, for example, any one of, some of, any combination of, or all of a long term storage system, such as a hard drive, a short term storage system, such as random access memory, a removable storage system, such as a floppy drive or a removable drive and/or flash memory. Memory system 230 may include one or more machine-readable mediums that may store a variety of different types of information. The term machine-readable medium is used to refer to any medium capable carrying information that is readable by a machine. One example of a machine-readable medium is a computer-readable medium. Memory system 230 may store one or more machine instructions to produce the merchant website 152 and the customer website 141 described and illustrated in FIG. 1 and its description or any other suitable website.

The memory system 230 may also include an operating system 231, a network communications module 232, a web browser module 233, a web server application 234, the customer website 141, and the merchant website 152. The customer website 141 includes a preferences page 241, a search page 242, an offer list page 243 and an offer and coupon detail page 244. The merchant website 152 includes a preference page 235, an offer and coupon posting page 236, an offer view page 237 and an offer search by code page 238. The operating system 231 is provided on the memory system 230. The communications module 232 enables the server system 200 to communicate on the communications network 122 and is stored on the memory system 230. The web browser module 233 allows for browsing the Internet that is stored on the memory system 230. The web server application 234 is software provided to allow for browsing on the Internet.

The processor system 240 may include any one of, some of, any combination of, or all of multiple parallel processors, a single processor, a system of processors having one or more central processors and/or one or more specialized processors dedicated to specific tasks. Processor system 240 may include one or more digital signal processors (DSPs) in addition to or in place of one or more central processing units (CPUs) and/or may have one or more digital signal processing programs that run on one or more CPU. Processor system 240 may implement the machine instructions stored in memory system 230.

The communication interface 250 allows the server system 200 to interface with the communications network 122 described in previous FIG. 1. Communications system 260 communicatively links output system 210, input system 220, memory system 230, processor system 240 and/or input/output system 270 to each other. Communications system 260 may include any one of, some of, any combination of, or all of electrical cables, fiber optic cables, and/or sending signals through air or water (e.g. wireless communications), or the like. Some examples of sending signals through air and/or water include systems for transmitting electromagnetic waves such as infrared and/or radio waves and/or systems for sending sound waves.

The input/output system 270 may include devices that have the dual function as input and output devices. For example, input/output system 270 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 270 is optional and may be used in addition to or in place of output system 210 and/or input device 220.

The server system 200 also includes a cryptography server 280 with a certificate authority key generator 282, a certificate authority key 284 and a public and private key generator 286.

FIG. 3 illustrates a block diagram of a client system 300 of a system of real-time tracking one or more transactions, in accordance with one embodiment of the present invention.

Client system 300 may include an output system 302, an input system 304, a memory system 306, a processor system 308, a communications system 312 and an input/output system 314. Other embodiments of client system 300 may not have all of the components and/or may have other embodiments in addition to or instead of the components listed above. The client system 300 may be any of the client systems 120 that may be used as one of the client systems 120 described and illustrated in FIG. 1. In other embodiments, the client system 300 may include additional components and/or may not include all of the components listed above.

Output system 302 may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, intranet, and/or the Internet, for example.

Input system 304 may include any one of, some of, any combination of, or all of a keyboard system, a mouse system, a track ball system, a track pad system, buttons on a handheld system, a scanner system, a wireless receiver, a microphone system, a connection to a sound system, and/or a connection and/or an interface system to a computer system, intranet, and/or the Internet (e.g., IrDA, USB), for example.

Memory system 306 may include, for example, any one of, some of, any combination of or all of a long term storage system, such as a hard drive, a short term storage system, such as random access memory, a removable storage system, such as a floppy drive or a removable drive, and/or a flash memory. Memory system 306 may include one or more machine readable mediums that may store a variety of different types of information. The term machine-readable medium is used to refer to any medium that is structurally configured for carrying information in a format that is readable by a machine. One example of a machine-readable medium is a computer-readable medium. Memory system 306 may store an application, if client system 300 is a server. Memory system 306 may also store machine instructions for tracking one or more transactions if the client system 300 is a server.

The processor system 308 may include any one of, some of, any combination of, or all of multiple parallel processors, a single processor, a system of processors having one or more central processors and/or one or more specialized processors dedicated to specific tasks. Processor system 308 implements the programs stored in the memory system 306.

Communications system 312 communicatively links output system 302, input system 304, memory system 306, processor system 308, and/or input/output system 314 to each other. Communications system 312 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 314 may include devices that have the dual function as input and output devices. For example, input/output system 314 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 314 is optional, and may be used in addition to or in place of output system 302 and/or input device 304.

The system and method for real-time tracking one or more transactions operates by a software token generator or a hardware security token that, upon request by a user, produces a cryptographic key. The hardware token may be alternatively referred to as a hard token or a cryptographic token. The user may be required to push a button on the hardware security token or a virtual button in a software application, to produce the password display.

The token may, for example, function in accordance with an encryption standard such as the proposed Pretty Good Privacy (PGP) open Standard currently denoted by RFC 4880, and defined by the Open PGP Working Group of the Internet Engineering Task Force. The Open PGP combines both symmetric-key encryption and public-key encryption to provide confidentiality. When made confidential, first the object is encrypted using a symmetric encryption algorithm. Each symmetric key is used only once, for a single object. A new “session key” is generated as a random number for each object (sometimes referred to as a session).

Since it is used only once, the session key is bound to the message and is transmitted with it. To protect the key, it is encrypted with the receiver's public key. The sequence is as follows. The sender creates a message. The sending software generates a random number to be used as a session key for this message only. The session key is encrypted using each recipient's public key. These “encrypted session keys” start the message. The sending software encrypts the message using the session key, which forms the remainder of the message. The message may also be compressed. Finally, the receiving software decrypts the session key using the recipient's private key.

When prompted in a conventional application of a hardware security token, the user enters a dynamic token password along with a User ID and a static password. The token serves as an additional level of security in a two-factor authentication process. However, in the disclosed real-time consumer offer and redemption tracking system, a User ID and a static password are not required for entry by the customer.

An offer (or coupon), having a unique offer number is generated by the system and method for real-time tracking one or more transactions. The unique number may be entered into an application database by a merchant, a customer, or an administrator of a remote system server. The offer is accessible after being logged in by a server side application in the system server. Accordingly, the merchant or the administrator can modify the offer corresponding to the offer in real-time, and provide updated information on a merchant website. In another embodiment of the present invention, the customer may present a coupon having indicia and descriptors identifying the coupon as having been issued by a particular merchant.

The offer may be presented to the customer based on a plurality of preferences, such as age, location, gender or other suitable information. Although preference details may be optional with the customer, the more information that can be provided by the customer, the better an offer can be customized or tailored to the preferences of the customer.

The customer may patronize a retail location to redeem the offer with a merchant, by presenting the offer on a client system or a mobile communication device. The merchant may subsequently generate a unique token number with the hardware or software token, which identifies the merchant and which the customer can enter in his mobile communication device to redeem the offer. The system and method for real-time tracking one or more transactions may measure such real-time consumer offer and redemption activity for the retail store and may further function to present the merchant with statistics from the system database. If a customer provides an offer number to a merchant without using a communication device, for example, the offer may be honored but the customer transaction would not be tracked by the system.

The customer may enter the token number into the system database and thereby receives points. However, if the customer is not known to the system and method for real-time tracking one or more transactions, the customer would not earn points for the transaction. The merchant may then be given real-time access to a detailed report outlining offer performance and related analytics. The merchant may have an option to receive the reports on a daily, weekly, or monthly basis.

The customer can track earned points in real-time by accessing a customer website via a customer communication device, such as a computer, a PDA, or other suitable mobile communication device. The customer can redeem the earned points for example, using a method similar to that used for redeeming credit card points or frequent flyer points.

In another embodiment of the present invention, the real-time consumer offer and redemption tracking system functions without a requirement that software be installed at a manufacturer side or a business point-of-sale or POS side. The system includes the hardware or software token which can generate and display a code by pressing a button that can be a hardware or virtual software button.

In one embodiment of the present invention, the customer of the business may enter the code in a mobile device such as, a cell phone or a personal data assistant or other suitable mobile device, or use a generic offer or coupon, and acquire the necessary code so as to identify which coupon or offer was used, at what merchant location the coupon or offer was redeemed and the time and day the coupon or offer was redeemed.

The coupons are entered in a relatively very easy web interface with only a couple of fields. There is nothing to install, and no elaborate software for the user to learn. What is presented to the user are entry fields, including one or more of the following: title of the offer, description of the offer, if applicable address of the corresponding business entity, coupon code or offer code, and if applicable, address of the corresponding business entity.

An administrator of the real-time consumer offer and redemption tracking system may perform additional tasks for both party's manufacturer and businesses, including identifying, validating and providing analytics reports for both the manufacturer and the business, providing an application platform that may include a marketing platform, a listing platform, and/or an advertising platform, entering offers after a business or manufacturer purchases an optional subscription plan and performing redemption and validation of the offers or coupons without requiring an extra step other than having the customer push a button on the hardware or software security token and reading the code shown on the security token.

Some of the advantages provided by the system and method for real-time tracking one or more transactions include no software for a customer to install, to use, or to learn if the customer uses the hardware token, no clearinghouse connection or hardware and maintenance are needed and relatively inexpensive components are used in the system. The corresponding software can be installed on a merchant's desktop machine, or in a POS system, or on a token generator mobile device. Alternatively, the merchant can use a web token generator by logging into an account in the system and method for real-time tracking one or more transactions. The web token generator can also be a standalone software module on a memory card or installed on a suitable machine without a web connection. When a consumer enters the tokens into a mobile device, the token redemption can be tracked even if the merchant is not online.

The system and method for real-time tracking one or more transactions also makes it relatively easier for the merchant to collect and track data, as well as making it easier for offerings, redeeming activity, and administering the system. The system may provide the merchant with a unique token generator and a website where the merchant can publish offers. The token generator, a unique merchant number, and an offer number are all correlated with one another. The customer, who redeems the offer using the server side application, the application platform, and the website, essentially “closes the circle.”

The real-time consumer offer and redemption tracking system offers an advantage that detailed information can be tracked unobtrusively with minimal distraction to the participants. In particular, the system can also track the merchant offerings, the customers, the times of customer transactions, the transaction locations, and other suitable demographic data such as one or more favorite foods, one or more favorite colors and one or more favorite drinks. Moreover, this data is obtained at no cost to the merchants or to the customers or, alternatively, may be provided as extra value.

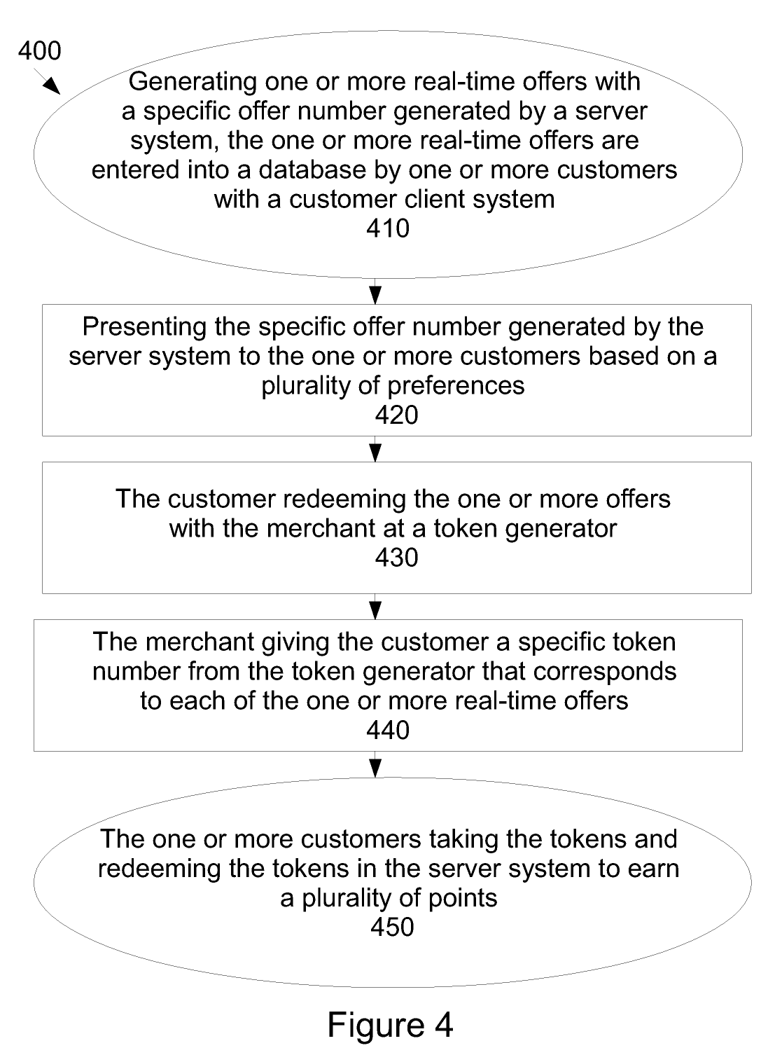

FIG. 4 illustrates a flowchart of a method 400 for real-time tracking one or more commercial transactions, in accordance with one embodiment of the present invention.

The method 400 steps include generating one or more real-time offers with a specific offer number generated by a server system, the one or more real-time offers are entered into a database by one or more customers with a customer client system 410, presenting the specific offer number generated by the server system to the one or more customers based on a plurality of preferences 420, the customer redeeming the one or more offers with a merchant at a token generator 430, the merchant giving the customer a specific token number from the token generator that corresponds to each of the plurality of tokens 440, and the one or more customers taking the tokens and redeeming the tokens in the server system to earn a plurality of points 450.

The generating step 410 includes the generated offer is entered into the database by a merchant with a merchant client system. The generating step 410 also includes the generated offer is entered into the database by an administrator with an administrator client system. The presenting step 420 includes the preferences that include age, location and gender. The one or more customers taking and redeeming the tokens step 450 includes the merchant accessing in real-time a detailed report outlining merchant performance and one or more analytics with a merchant client system. The one or more customers taking and redeeming the tokens step 450 also includes the one or more customers tracking the earned plurality of points with a customer client system on a client website that resides on the server system. The one or more customers taking and redeeming the tokens step 450 also includes the tokens producing a cryptographic key.

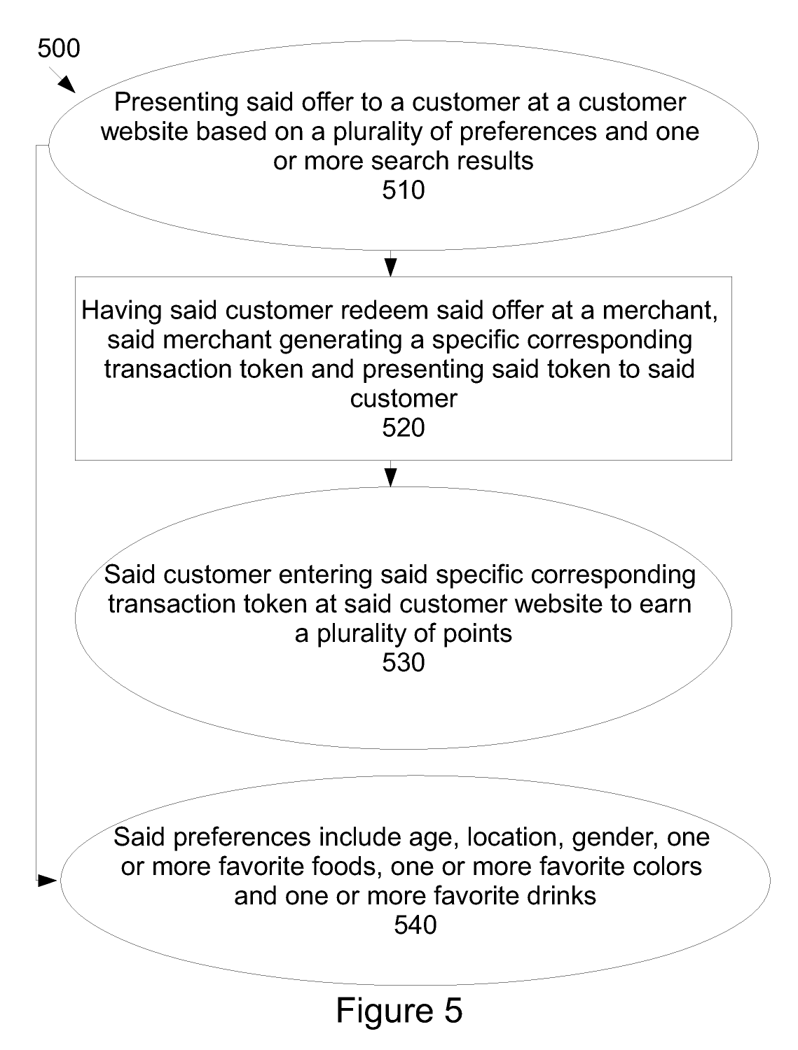

FIG. 5 illustrates a flowchart of a method for generating an offer with a specific corresponding offer code, in accordance with one embodiment of the present invention.

The method 500 includes the steps of presenting the offer to a customer at a customer website based on a plurality of preferences and one or more search results 510, having the customer redeem the offer at a merchant, the merchant generating a specific corresponding transaction token and presenting the token to the customer 520 and the customer entering the specific corresponding transaction token at the customer website to earn a plurality of points 530. The preferences include age, location, gender, one or more favorite foods, one or more favorite colors and one or more favorite drinks.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system of real-time tracking one or more transactions, comprising:
a server system with a processor system, a communications interface, a communications system, an input system, an output system and a input and output system having access to a communications network, the server system generates one or more offers and allows the one or more offers entered into said server system to track performance of said entered one or more offers;
a memory system with an operating system, a communications module, a web browser module and a web server application, said memory system resides on said server system;
one or more customers that enter said one or more specific offer numbers of said one or more offers into said server system, said one or more customers utilizes a customer client system over said communications network;
one or more merchants provided with real-time access to a detailed report outlining merchant performance, said detailed report provided with one or more related analytics;
one or more merchants that change said one or more offers that reside on said server system in real-time, said one or more merchants utilize a merchant client system;
an administrator that change said one or more offers that reside on said server system in real-time, said administrator utilizes an administrator client system;
a token generator that generates a plurality of tokens; and
a plurality of websites that include a customer website, a merchant website and a merchant website.

2. The system according to claim 1, wherein said one or more offers is one or more coupons.

3. The system according to claim 1, wherein said one or more offers include a specific offer number that corresponds to each said one or more offers.

4. The system according to claim 1, wherein said one or more customers redeem said one or more offers with said one or more merchants by utilizing said token generator that generates a plurality of tokens, said tokens each have a specific token number that corresponds to each said token.

5. The system according to claim 4, wherein said one or more customers enter said specific token numbers into said server system and earn a plurality of points.

6. The system according to claim 1, wherein said client systems are selected from the group consisting of a smartphone, a table computer, a laptop computer or a personal computer.

7. The system according to claim 1, wherein said one or more customers track said points that reside on said server system in real-time with said customer client system.

8. The system according to claim 1, wherein said one or more customers receive said one or more offers from said server system based on a plurality of preferences.

9. The system according to claim 8, wherein said preferences include age, location, gender, one or more favorite foods, one or more favorite colors and one or more favorite drinks.

10. The system according to claim 1, wherein said customer website includes a preferences page, a search page, an offer list page and an offer and coupon detail page.

11. The system according to claim 1, wherein said merchant website includes a preference page, an offer and coupon posting page, an offer view page and an offer search by code page.

12. The system according to claim 1, wherein said server system includes a cryptography server with a certificate authority key generator, a certificate authority key and a public and private key generator.

13. The system according to claim 1, wherein said token generator generates said tokens with a one-time development cost replicated at little cost.

14. A method for real-time tracking one or more transactions, comprising the steps of:
generating one or more real-time offers with a specific offer number generated by a server system, said one or more real-time offers are entered into a database by one or more customers with a customer client system;
presenting said specific offer number generated by said server system to said one or more customers based on a plurality of preferences said customer redeeming said one or more offers by a merchant with a token generator;
said merchant giving said customer a specific token number from said token generator that corresponds to each of said plurality of tokens; and
said one or more customers taking said tokens and redeeming said tokens in said server system to earn a plurality of points.

15. The method according to claim 14, wherein said generated offer is entered into said database by an administrator with an administrator client system.

16. The method according to claim 14, wherein said preferences include age, location, gender, one or more favorite foods, one or more favorite colors and one or more favorite drinks.

17. The method according to claim 14, wherein said merchant is accessing in real-time a detailed report outlining merchant performance and one or more analytics with a merchant client system.

18. The method according to claim 14, wherein said one or more customers track said earned plurality of points with a customer client system on a client website that resides on said server system.

19. A method for generating an offer with a specific corresponding offer code, comprising the steps of:
presenting said offer to a customer at a customer website based on a plurality of preferences and one or more search results, having said customer redeem said offer at a merchant, said merchant generating a specific corresponding transaction token and presenting said token to said customer; and
said customer entering said specific corresponding transaction token at said customer website to earn a plurality of points.

20. The method according to claim 19, wherein said preferences include age, location, gender, one or more favorite foods, one or more favorite colors and one or more favorite drinks.
